(19) United States
(12) Patent Application Publication
(10) Pub. No.: US 2009/0299553 A1
(43) Pub. Date: Dec. 3, 2009

(54) Satellite Control

(75) Inventor: Dean Richard HOPE, London (GB)

Correspondence Address: STERNE, KESSLER, GOLDSTEIN & FOX P.L.L.C., 1100 NEW YORK AVENUE, N.W., WASHINGTON, DC, 20005, US

(73) Assignee: Inmarsat Global Limited, London (GB)

(21) Appl. No.: 12/474,059

(22) Filed: May 28, 2009

(30) Foreign Application Priority Data
May 29, 2008 (GB) 0809799.0

(51) Int. Cl. G05D 1/00; B64G 1/26; B64G 1/40; B64G 1/66

(52) U.S. Cl. 701/13; 244/169

(57) ABSTRACT

A satellite has a depletion detector arranged in a propellant line such that, when depletion is detected, the amount of propellant remaining in the propellant lines is sufficient to dispose of the satellite, and may include a margin sufficient for 6-12 months of stationkeeping. This provides a simple and reliable method of determining when decommissioning is required.

### FIELD OF THE INVENTION

The present invention relates to a method of controlling a satellite during its disposal phase, and to a satellite arranged to facilitate such control.

### BACKGROUND OF THE INVENTION

There is an ever-increasing number of objects in earth orbit, particularly at geostationary altitudes. Satellite operators are therefore concerned at the risk of their satellites colliding with such objects. Many of those objects are remnants of decommissioned satellites. As a result, new ISO and IADC (Inter-agency Debris Coordination Committee) standards will shortly come into force, requiring that satellite operators dispose of their satellites in a disposal orbit at least 300 km above the geostationary arc on decommissioning; see for example ‘Managing Satellites' End of Life: Critical for the Future of Space’ by Laurence Lorda, Space Operations Communicator July-September 2006. For LEO (low-earth orbit) satellites, the IADC recommends that satellites be deorbited so as to re-enter the atmosphere and burn up.

A satellite operator must therefore ensure that a ‘disposal mass’ of propellant remains in the satellite after it is decommissioned, sufficient to place the satellite in the required disposal orbit in the case of geosynchronous satellites, or to cause the satellite to re-enter the atmosphere in the case of a LEO orbit.

However, the quantity of propellant remaining in a satellite is subject to uncertainty; an operator must ensure that at least the disposal mass of propellant remains, within the bounds of this uncertainty. Various methods are used to estimate the amount of propellant remaining. In a ‘bookkeeping’ method, the amount of propellant remaining is tracked by subtracting the mass required for each manoeuvre from the initial propellant loading at launch; the mass per manoeuvre is calculated from the thrusters' on-times and the nominal mass flow rate. In a thermal method, the mass of remaining propellant is estimated by heating the propellant tanks and observing the heating and cooling time constants. In a depletion method, a tank is determined to be empty when pressurising gas is detected in a propellant line between a tank and the thrusters, when the temperature of the thrusters drops, by a detected loss of thrust, or by a sudden increase in the rate of pressure drop.

Existing methods of estimating remaining propellant are inaccurate; for example, the typical liquid apogee engine (LAE) performance uncertainty is about 1%, and almost 90% of propellant is used for apogee firing, so that the percentage uncertainty in fuel remaining for stationkeeping is approximately 10%. As a result, satellites are often decommissioned when the mass of remaining propellant is far in excess of the disposal amount, thus shortening the useful life of the satellite unduly and wasting potential revenue. For example, the Inmarsat 2 F3 satellite, decommissioned in 2006, had a target disposal orbit of 200 km above the geostationary arc, with a budgeted increase in orbital velocity (Δv) of 7 ms⁻¹. For test purposes the thrusters were fired until complete depletion of the propellant, which gave Δv of 42 ms⁻¹, and an altitude more than 1200 km above geostationary. The excess propellant, equivalent to Δv of 35 ms⁻¹, could have been used to maintain East-West stationkeeping for up to 10 more years. A detailed analysis of this decommissioning process is given in ‘Decommissioning of the Inmarsat 2F3 satellite’, Hope D R, Journal of Aerospace Engineering December 2007, Vol. 221 No G6 ISSN 0954-4100.

Patent publication WO-A-2006/005833 proposes a depletion method in which pressure sensors, interposed in the propellant lines between the tanks and the thrusters, are used to detect the loss or damping of pressure waves caused by opening or closing valves in the propellant lines, so as to detect complete draining of the propellant tanks.

### STATEMENT OF THE INVENTION

According to one aspect of the present invention, there is provided a satellite having one or more propellant storage tanks, one or more thrusters, and one or more propellant lines for providing propellant from the tanks to the thrusters, the satellite further comprising a depletion detector for detecting depletion of propellant at a location in the one or more propellant lines, the location being arranged such that, the depletion is first detected, the amount of propellant remaining in the propellant lines is greater than a predetermined disposal amount by a predetermined margin. The margin may be sufficient for 6-12 months of stationkeeping.

The depletion detector and/or the propellant lines may be arranged so that the propellant remaining between the depletion detector and the stationkeeping thrusters is greater than the disposal amount by the predetermined margin. The stationkeeping thrusters are typically those responsible for East-West stationkeeping in geosynchronous orbits. Hence, for geosynchronous satellites, the margin may be equivalent to 6-12 months of East-West stationkeeping. In non-geosynchronous satellites, such as LEO or MEO satellites, the margin may be equivalent to 6-12 months of constellation adjustment or phasing manoeuvres.

According to another aspect of the present invention, there is provided a method of controlling a satellite according to the first aspect of the invention, the method comprising detecting depletion of the propellant using the depletion detector, decommissioning the satellite in response thereto, and controlling the satellite to enter a predetermined disposal orbit after decommissioning.

Advantageously, the present invention may allow more accurate determination that the remaining propellant has reached the disposal mass, with the predetermined margin, thus avoiding premature decommissioning of the satellite.

### BRIEF DESCRIPTION OF THE DRAWINGS

There now follows, by way of example only, a detailed description of preferred embodiments of the present invention in which:

FIG. 1 is a schematic diagram of a satellite in geosynchronous orbit controlled by a ground station; and

FIG. 2 is a schematic diagram of a propulsion system of satellite in an embodiment of the present invention.

### DETAILED DESCRIPTION OF THE EMBODIMENTS

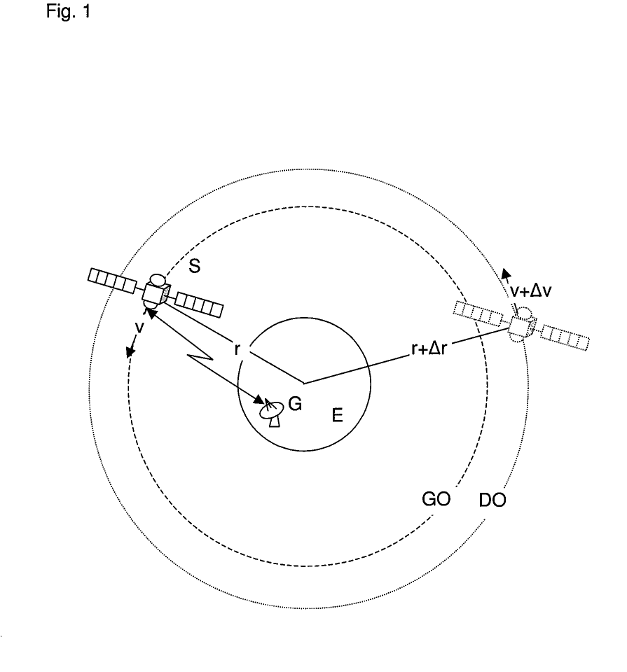

In an example shown in FIG. 1, a satellite S is in geosynchronous orbit GO, at an orbital radius r from the centre of the earth E of approximately 42,164 km, with an orbital velocity v of approximately 3.07 km/s. The orbital velocity v is related to the orbital radius r by the equation:

r=μ/v² (1)

where μ is the geocentric gravitational constant:
μ=G.M_{E}=398,600 km³s⁻²

The satellite S is in communication with a ground station G, such as a TT&C (telemetry, tracking and control) station, which receives information from sensors on the satellite S and sends commands to the satellite S, including commands to a propulsion system on the satellite. Periodically, the propulsion system is operated so as to perform stationkeeping i.e. to prevent the satellite S deviating from its intended position in the geostationary arc by more than a predetermined degree. These operations gradually deplete the propellant remaining in the satellite and effectively determine the operational lifetime of the satellite.

When it is determined that the satellite S is to be decommissioned, the services supported by the satellite must first be concluded or reassigned so that the satellite S is no longer operational. For example, where the satellite S is a telecommunications satellite, bandwidth available via the satellite S must be reassigned to another satellite, which may be a replacement satellite or an in-orbit spare. Once the satellite S has been decommissioned, the ground station G controls the propulsion system to increase the orbital velocity v of the satellite S so as to increase the orbital radius into a disposal orbit DO. For example, in order to increase the orbital radius r by Δr=200 km, Δv≈7 ms⁻¹.

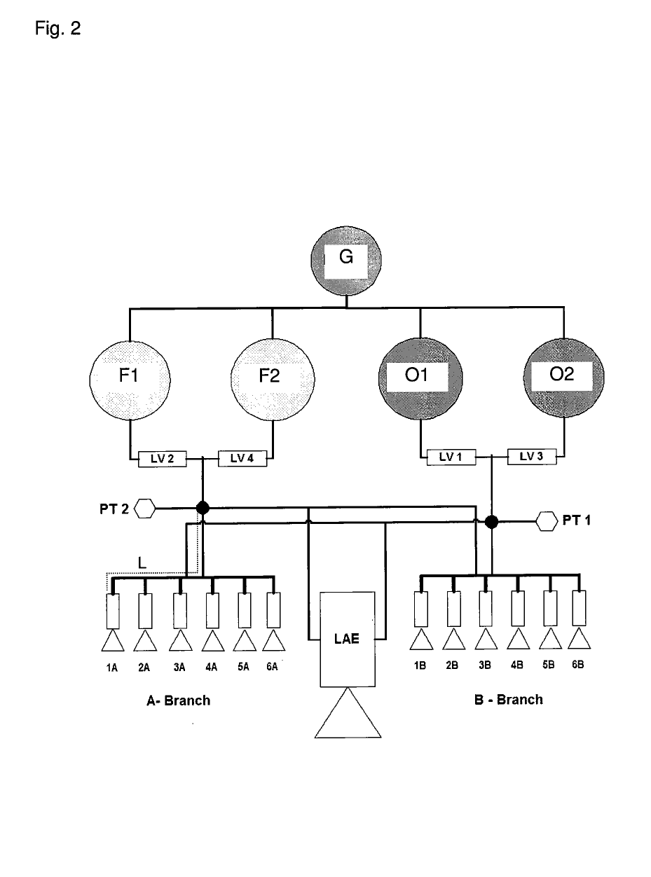

FIG. 2 shows a satellite propulsion system according to an embodiment of the invention, based on the propulsion system of an Inmarsat 2 satellite. The Inmarsat 2 satellite uses a bi-propellant system comprising first and second fuel tanks F1 and F2, containing a liquid fuel such as monomethylhydrazine (MMH), and first and second oxidiser tanks O1 and O2, containing a liquid oxidiser such as nitrogen tetroxide (NTO). The contents of the tanks are pressurised by gas, such as helium stored in a gas tank G. The outlets of the tanks are controlled by respective liquid valves LV1-LV4. The fuel and oxidizer are supplied from the tanks through propellant lines to redundant branches (A-Branch and B-Branch) of thrusters 1A-6A and 1B-6B, and to a liquid apogee engine LAE, each of which include respective inlet valves. A burn is performed by opening the valve to the respective thrusters so that the required amount of fuel and oxidiser is combined and burns in the thrusters.

In this embodiment, pressure transducers PT1 and PT2 are located at specific positions in the propellant lines between the tanks F1, F2, O1, O2 and the thrusters 1A-6A and 1B-6B. The pressure transducers PT1, PT2 are arranged to detect depletion of oxidiser and fuel respectively at their respective positions. In other words, pressure transducer PT1 detects when oxidiser is no longer present at its specific location, while pressure transducer PT2 detects when fuel is no longer present at its specific location.

The specific locations are selected and/or the propellant lines are designed so that the respective masses of fuel and oxidiser downstream of the locations are sufficient for disposal of the satellite S from the geostationary orbit GO to the disposal orbit DO. For example, the required fuel mass may be calculated from the ideal rocket equation as follows:

Δm=m₀[e(ΔV/gIₛₚ)−1] (2)

where
m₀ is the total mass of the satellite immediately before disposal
Iₛₚ is the specific impulse

For example, for Δr=200 km, the equivalent required fuel mass for an Inmarsat 2 satellite is approximately 800 g and the required oxidant mass is approximately 1.2 kg.

The onboard fuel is hydrazine which has the density of water (1 g/ml) and the oxidiser is nitrogen tetroxide with a density 1.6 times less than that of hydrazine. A typical fuel line is a circular tube of titanium, with a diameter of either ⅜″ (9.5 mm) or ¼″ (6.4 mm). A 1-metre length of ¼″ (6.4 mm) pipe contains a fuel mass of 32 g and a ⅜″ pipe (9.5 mm) contains a fuel mass of 48 g, so 800 g of fuel equates to ˜25 metres of ¼″ (6.4 mm) pipe or ˜16.7 metres of ⅜″ (9.5 mm) pipe. A similar calculation may be made for the required oxidant mass. Hence, in relation to the size of the satellite, the pipe lengths and diameters are arranged to hold the necessary disposal fuel and oxidant mass. Relative to existing satellite designs, this may involve an increase in the pipe lengths and/or diameters, and/or repositioning of depletion sensors.

However, since it is impractical to dispose of a satellite as soon as depletion is detected, the required fuel and oxidant mass preferably includes a margin sufficient to allow the satellite S to be decommissioned prior to disposal. A margin equivalent to Δv=2 ms⁻¹, which will allow 6 to 12 months of East-West stationkeeping for a typical geostationary satellite, should be sufficient, which is still very much less than the margin of several years applied in existing satellites.

In an embodiment of the invention, satellite decommissioning is initiated in response to the detection of propellant depletion at the specific point(s) in the propellant lines, and disposal is initiated once the satellite has been decommissioned, preferably no more than 6 months after depletion is detected. This method may be performed at the ground station G, or the satellite S may include a suitably programmed computer arranged to perform the decommissioning and/or disposal automatically or semi-automatically.

Hence, embodiments of the invention provide a simple and reliable method of determining when decommissioning is required, without requiring excess propellant to be carried. Effectively, the propellant lines provide an emergency in-line tank sufficient for disposal of the satellite S.

The dimensioning of propellant lines and location of depletion sensors need only be applied to propellant lines that feed thrusters used for stationkeeping, and only those required for increasing the orbital velocity, such as one or more thrusters arranged to provide thrust in an Easterly direction. The relevant thruster(s) may be one or more nominal or designated East thrusters. For example, in a case where the nominal East thruster may have failed, an operator may control the satellite to rotate at the time of disposal so that another thruster becomes the designated East thruster. In a specific example as shown in FIG. 2, the length of pipe L between the pressure transducer PT2 and the relevant thruster 1A, has a fuel capacity of at least 800 g and L≧16.7 m if the pipe has an internal diameter of ⅜″ (9.5 mm).

The pressure transducers PT1 and PT2 may be as described in WO-A-2006/005833, but any other suitable type of depletion sensor may be used, such as an optical sensor, in order to detect depletion at a specific point in a propellant line.

Embodiments of the invention are applicable to monopropellant propulsion systems, which do not require separate fuel and oxidiser tanks and lines; instead, the monopropellant may be burned by contact with a catalyst in the thrusters, or there may be no catalyst in the case of ‘cold gas’ systems. In this case, only one depletion sensor may be required.

Embodiments of the invention are also applicable to LEO and MEO (medium earth orbit) satellites, with the required disposal fuel mass being calculated according to the disposal trajectory required for that satellite. The margin may be calculated to allow for 6-12 months of constellation adjustment or phasing manoeuvres.

The embodiments described above are illustrative of rather than limiting to the present invention. Alternative embodiments apparent on reading the above description may nevertheless fall within the scope of the invention.

1. A satellite having a propulsion system comprising a propellant tank, a propellant line, and a thruster operable to propel the satellite into a disposal trajectory, the propellant line including a depletion sensor for sensing propellant depletion at a predetermined sensor location in the propellant line, wherein the capacity of the propellant line between the sensor location and the thruster is sufficient to propel the satellite into the disposal trajectory.

2. The satellite of claim 1, wherein the capacity of the propellant line between sensor location and the thruster exceeds that required to propel the satellite into the disposal trajectory by a predetermined margin.

3. The satellite of claim 2, wherein the thruster is operable to perform stationkeeping of the satellite.

4. The satellite of claim 3, wherein said margin is equivalent to between 6 and 12 months' stationkeeping of the satellite.

5. The satellite of claim 4, wherein the satellite is arranged as a geosynchronous satellite, and said margin is equivalent to between 6 and 12 months of East-West stationkeeping of the satellite.

6. The satellite of claim 5, wherein said margin is sufficient to provide a change in orbital velocity of the satellite of up to 2 ms⁻¹.

7. The satellite of claim 1, wherein the satellite is arranged as a geosynchronous satellite, and the thruster is arranged to provide thrust in an Easterly direction.

8. The satellite of claim 4, wherein the satellite is a non-geosynchronous satellite, and said margin is equivalent to between 6 and 12 months' phasing or constellation adjustment of the satellite.

9. The satellite of claim 1, arranged as a geosynchronous satellite.

10. The satellite of claim 9, positioned in a geosynchronous orbit.

11. The satellite of claim 1, arranged as a low or medium earth orbit satellite.

12. The satellite of claim 11, positioned in said respective low or medium earth orbit.

13. The satellite of claim 1, wherein the depletion sensor comprises a pressure sensor arranged to sense loss or damping of pressure waves caused by opening or closing of a valve in the propellant line.

14. A method of controlling disposal of a satellite, the satellite being as claimed in any preceding claim, wherein the method comprises receiving an indication from the depletion sensor that the propellant is depleted at the sensor location, and decommissioning the satellite in response to said indication, the method further comprising controlling the thruster to propel the satellite into the disposal trajectory.

15. A computer program comprising program code means arranged to perform the method of claim 14.

16. (canceled)
